(19) United States
(12) Patent Application Publication
(10) Pub. No.: US 2014/0318852 A1
(43) Pub. Date: Oct. 30, 2014

(54) SHIELD STRUCTURE AND WIRE HARNESS

(71) Applicant: YAZAKI CORPORATION, Tokyo (JP)

(72) Inventors: Hideomi Adachi, Shizuoka (JP); Yoshiaki Ozaki, Shizuoka (JP)

(73) Assignee: Yazaki Corporation, Tokyo (JP)

(21) Appl. No.: 14/359,855

(22) PCT Filed: Nov. 21, 2012
(86) PCT No.: PCT/JP2012/080807

§ 371 Date: May 21, 2014

(30) Foreign Application Priority Data
Nov. 25, 2011 (JP) 2011-256942

(51) Int. Cl. H01B 9/02

(52) U.S. Cl. CPC H01B 9/024
USPC 174/350; 174/72 A

(57) ABSTRACT

A shield structure and a wire harness are provided which can improve a working property, reduce the number of parts and lower a cost when a shield member is fixed and integrally formed. In the shield structure, a tubular electromagnetic shield member 40 is fixed to and formed integrally with a motor side connecting part 42 and an inverter side connecting part 43 by a resin molding. Specifically, the motor side connecting part 42 and the inverter side connecting part 43 are formed as electrically conductive molded products and an integral molding operation is carried out when a terminal part of the electromagnetic shield member 40 is integrally formed with the electrically conductive molded products respectively.

### TECHNICAL FIELD

The present invention relates to a shield structure including a shield member formed in a tubular shape and a wire harness using the shield structure.

### BACKGROUND ART

A high tension wire harness that electrically connects devices mounted on a vehicle such as an electric vehicle or a hybrid motor vehicle is disclosed in detail in, for instance, below-described patent literature 1. The below-described patent literature 1 is proposed by the applicant of this application and will be briefly described below.

In FIGS. 9A and 9B, a wire harness 1 includes a plurality of high tension electric wires 2, a braided shield member 3 which covers the plurality of high tension electric wires 2 together, a shield shell 4 fixed to a shield case of a device not shown in the drawing, an annular member 5 held by the braided shield member 3 and a band 8 whose diameter is reduced by fasting a bolt 6 and a nut 7. The annular member 5 and the band 8 are used when a terminal part 9 of the braided shield member 3 is fixed to an annular part 10 of the shield shell 4.

In FIGS. 9A, 9B and 10, the braided shield member 3 is formed with a tubular braided conductor and includes a main body part 11 and the terminal part 9 continuous to the main body part 11. The terminal part 9 is formed in such a way that an inside diameter thereof is expanded more than an inside diameter of the main body part 11. Specifically, the terminal part 9 is formed so as to expand the inside diameter by force. The terminal part 9 is formed in a double structure by bending a terminal 12 inside in an axial direction. The double structure is formed so as to have an outer terminal part 13 and an inner terminal part 14. The terminal part 9 is formed so as to correspond to the part of a range shown by a quotation mark D. The inner terminal part 14 formed by bending the terminal inside is formed within the range shown by the quotation mark D.

In order to fix the terminal part 9 of the braided shield member 3 to the annular part 10 of the shield shell 4, initially, the annular member 5 is arranged between the outer terminal part 13 and the inner terminal part 14 and an operation is carried out for inserting the braided shield member 3 to the shield shell 4 so as to locate the annular part 10 inside the inner terminal part 14. Then, the annular part 10 is caulked. Finally, when the band 8 is fastened to the position of the annular part 10 from an outer side of the outer terminal part 13, the terminal part 9 of the shield member 3 is completely fixed to the annular part 10 of the shield shell 4 as described above.

In the above-described form and structure, since the inside diameter of the terminal part 9 is expanded more than the inside diameter of the main body part 11, a mesh 15 shown in FIG. 10 is opened larger than a mesh 16 of the main body part 11. When an opening area of the mesh 15 is large, there is a fear that a shield performance may be possibly lowered. However, since the terminal part 9 is formed in the double structure, the deterioration of the performance is prevented. Further, since the inner terminal part 14 is formed in the range shown by the quotation mark D, the deterioration of the performance is prevented.

Here, a supplemental explanation of the braided conductor is given below. One of the meshes 15 is called a pick 17. The pick 17 is formed with one or more metal element wires 18. The number of the metal element wires 18 is called a holding number and the number of picks 17 in one round of the braided conductor is called a driving number. The above-described supplemental explanation is disclosed in below-described patent literature 2 proposed by the applicant of this application.

### CITATION LIST

### Patent Literature

[PTL 1] Japanese Patent Publication No. JP-A-2005-339933
[PTL 2] Japanese Patent Publication No. JP-A-2008-262759

### SUMMARY OF INVENTION

### Technical Problem

In the above-described related art, when the terminal part 9 of the braided shield member 3 is fixed to the annular part 10 of the shield shell 4, that is, when the braided shield member 3 is formed integrally with the shield shell 4, many operation processes need to be carried out. Thus, a problem arises that a working property is low and a cost is high. Further, when the braided shield member 3 is fixed and formed integrally, the annular member 5, the bolt 6, the nut 7 and the band 8 are necessary. Thus, problems arise that the number of parts is large to make a management complicated or the cost is high.

The present invention is devised by considering the above-described circumstances and it is an object of the present invention to provide a shield structure and a wire harness which can improve a working property, reduce the number of parts and lower a cost when a shield member is fixed and integrally formed.

### Solution to Problem

In order to achieve the object described above, a shield structure according to the invention are characterized by the following (1) to (3).

(1) A shield structure having a shield member and an electrically conductive molded product, in which a terminal part of the shield member formed in a tubular shape is formed integrally with the electrically conductive molded product.

According to the present invention having such a feature, the shield member is fixed and formed integrally by a molding operation. An object to which the shield member is fixed and integrally formed is the electrically conductive molded product. The shield member is electrically connected to the electrically conductive molded product only by forming the terminal part thereof integrally with the electrically conductive molded product.

(2) In the shield structure as described above, the molded product may be formed as a fixing member fixed to a mate member having an electric conductivity.

According to the present invention having such a feature, the electrically conductive molded product is formed as the fixing member and the fixing member can be fixed to the electrically conductive mate member. A fixing member having an electric conductivity may be used as a substitute of, for instance, a metal shell.

(3) In the shield structure as described above, the molded product may be formed in the shape of a tubular body

According to the present invention having such a feature, the electrically conductive molded product is formed in a tubular shape. When the tubular body is formed, the shield member is fixed and formed integrally so as to be continuous to the tubular body. An electrically conductive tubular body may be used as a substitute of, for instance, a metal pipe.

In order to achieve the object described above, a wire harness according to the invention are characterized by the following (4).

(4) A wire harness including: one or a plurality of electrically conductive paths; a shield member which is formed in a tubular shape and covers the one or the plurality of electrically conductive paths and an electrically conductive molded product formed integrally with a terminal part of the shield member.

According to the present invention having such a feature, the wire harness is provided which includes the shield structure of the present invention defined above.

### Advantageous Effects of Invention

According to the invention defined in the above (1), since the shield structure is formed in such a way that the shield member is formed in the tubular shape and the electrically conductive molded product is formed integrally with the terminal part of the shield member, when the shield member is fixed and formed integrally, a working property can be effectively improved, the number of parts can be reduced and a cost can be lowered. Specifically, since operation processes are reduced and an annular member, bolts, nuts and a band are not necessary, the working property can be effectively improved, the number of parts can be reduced and the cost can be lowered.

Further, according to the invention defined in the above (2), since the fixing member that may be used as a substitute of, for instance, the metal shell is the electrically conductive molded product, the shield structure having the same using form as that of the usual shield structure can be effectively employed.

Further, according to the invention defined in the above (3), since the electrically conductive molded product is formed in the tubular shape, the shield structure can be effectively employed in which the tubular body is used as a substitute of, for instance, the metal pipe.

Further, according to the invention defined in the above (4), when the shield member is fixed and formed integrally, since the working property can be improved, the number of parts can be reduced and the cost can be lowered, a better wire harness can be effectively provided.

### BRIEF DESCRIPTION OF DRAWINGS

FIGS. 1A and 1B are diagrams showing a shield structure and a wire harness according to a first exemplary embodiment of the present invention.

FIG. 2 is an enlarged perspective view of the shield structure.

FIGS. 3A and 3B are diagrams of an outer sheath member.

FIG. 4 is an enlarged perspective view of a shield structure as another exemplary embodiment (a second exemplary embodiment).

FIGS. 5A to 5C are explanatory views of a loosened state of FIG. 4.

FIG. 6 is an enlarged perspective view of a shield structure as a still another exemplary embodiment (a third exemplary embodiment).

FIG. 7 is a sectional view of a shield structure as other exemplary embodiment (a fourth exemplary embodiment).

FIG. 8 is a sectional view of a cut state of a high tension electric wire.

FIGS. 9A and 9B are diagrams showing a shield structure of a usual example.

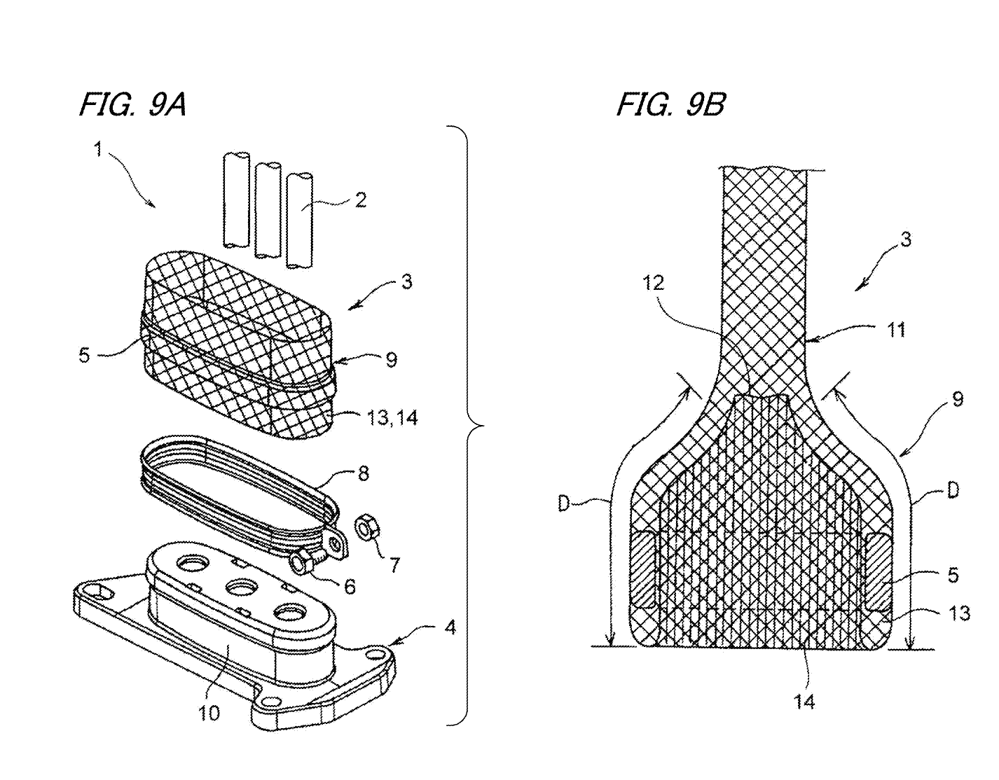

FIG. 10 is a diagram of a braided shield member shown in FIGS. 9A and 9B.

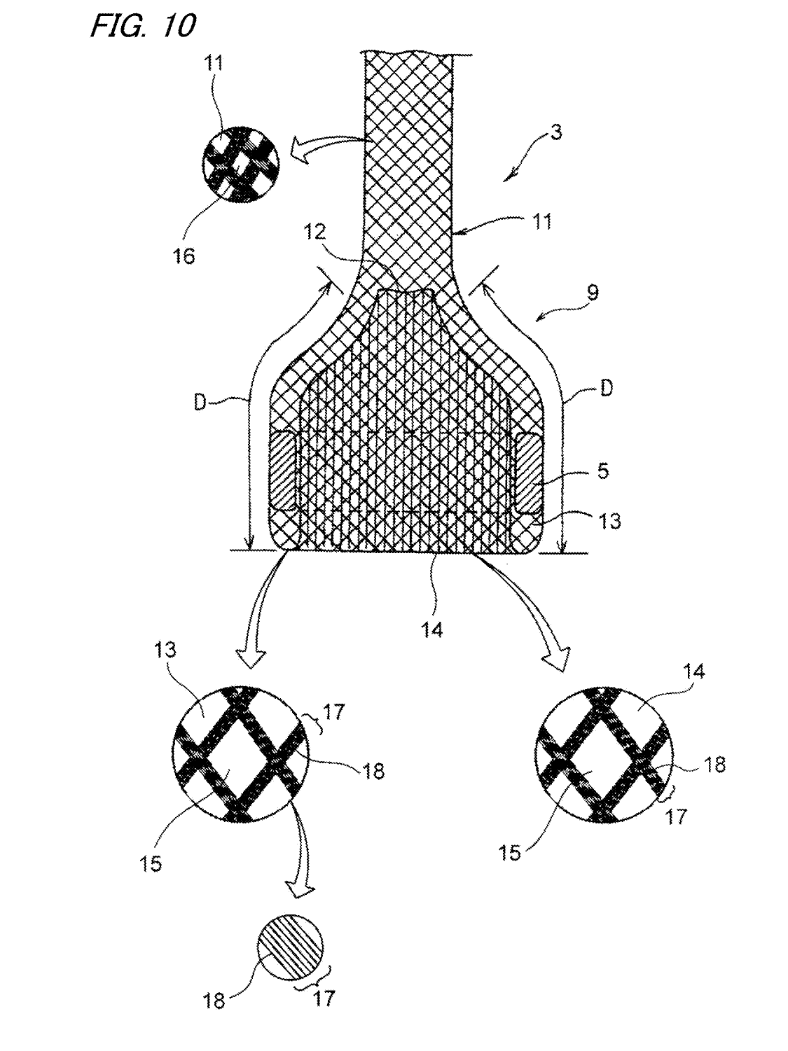

### DESCRIPTION OF EMBODIMENTS

An electrically conductive molded product is formed by filling a metal mold with a material and a shield member is also integrally formed during the molding. By the integral molding operation, a shield structure is realized in which a working property is improved, the number of parts is reduced and a cost is lowered.

### First Exemplary Embodiment

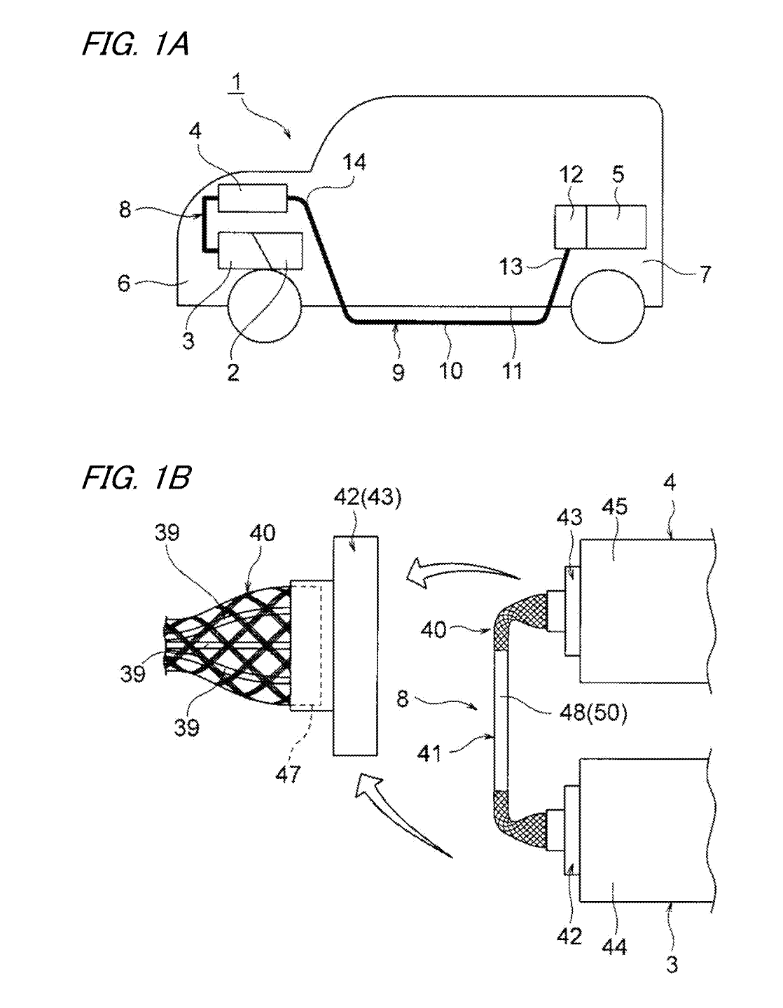

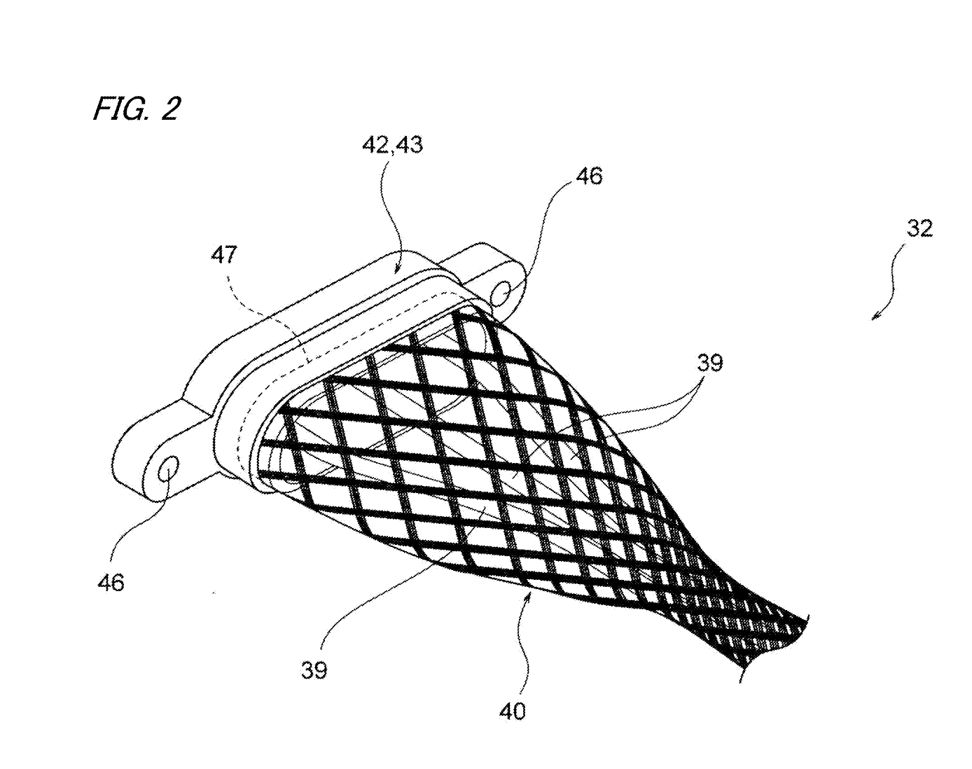

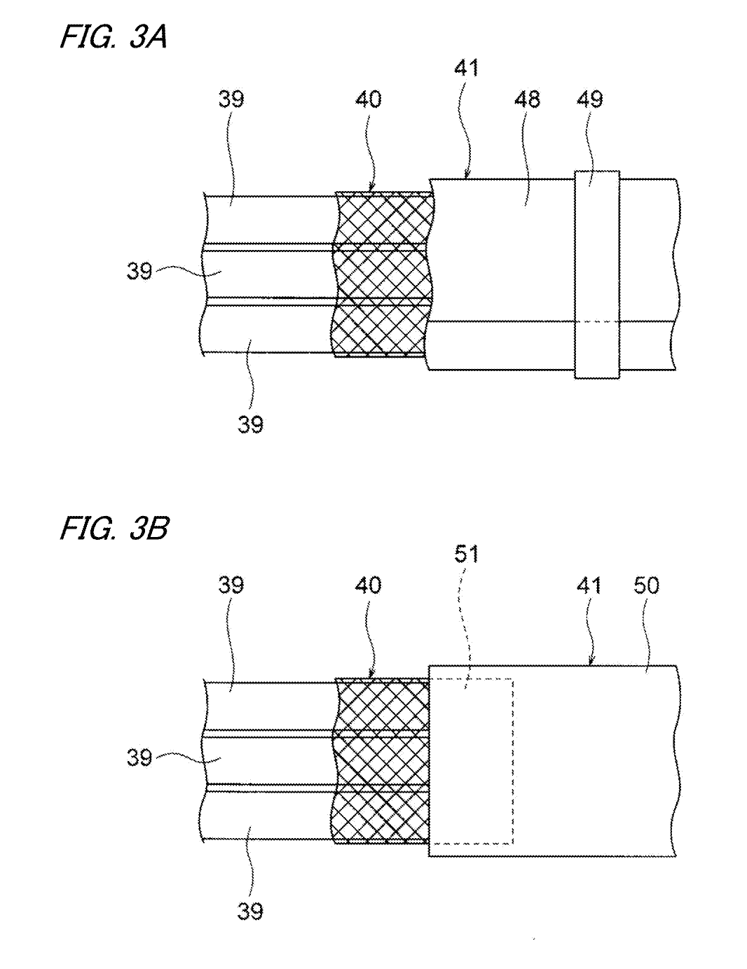

Now, referring to the drawings, a first exemplary embodiment will be described below. FIGS. 1A and 1B are diagrams showing a shield structure and a wire harness of the present invention. FIG. 2 is an enlarged perspective view of the shield structure. FIGS. 3A and 3B are diagrams of an outer sheath member.

In the present exemplary embodiment, an example is exemplified and explained which uses the shield structure and the wire harness of the present invention in a hybrid motor vehicle. An electric vehicle may be used instead of the hybrid motor vehicle.

In FIG. 1A, reference numeral 1 shows the hybrid motor vehicle. The hybrid motor vehicle 1 is a vehicle driven by mixing two powers of an engine 2 and a motor unit 3. To the motor unit 3, an electric power from a battery 5 (a battery pack) is supplied through an inverter unit 4. The engine 2, the motor unit 3 and the inverter unit 4 are mounted on an engine room 6 at a position where front wheels are located in the present exemplary embodiment. Further, the battery 5 is mounted on a rear part 7 of the motor vehicle in which rear wheels are located (the battery may be mounted on a motor vehicle room located in a rear part of the engine room 6).

The motor unit 3 is connected to the inverter unit 4 by a high tension wire harness 8. Further, the battery 5 is connected to the inverter unit 4 by a high tension wire harness 9. The wire harness 9 is formed for a high tension voltage. The wire harness 9 has an intermediate part 10 wired in the ground side of an under-floor 11 of a vehicle body and substantially in parallel along the under-floor 11 of the vehicle body. The under-floor 11 of the vehicle body is a well-known body, and what is called a panel member and has a through hole (its reference numeral is omitted) formed at a prescribed position. Into the through hole, the wire harness 9 is inserted.

The wire harness 9 is connected to the battery 5 through a junction block 12 provided in the battery 5. To the junction block 12, a rear end 13 of the wire harness 9 is electrically connected by a known method. A front end 14 side of the wire harness 9 is connected to the inverter unit 4 by a know method.

The motor unit 3 includes a motor and a generator in a structure. Further, the inverter unit 4 includes an inverter and a converter in a structure. The motor unit 3 is formed as a motor assembly including a shield case. Further, the inverter unit 4 is also formed as an inverter assembly including a shield case. The battery 5 is an Ni-MH type or an Li-ion type and formed as a module. For instance, a storage battery such as a capacitor may be used. The battery 5 is not especially limited as long as the battery 5 can be used for the hybrid motor vehicle 1 or the electric vehicle.

Initially, the form and structure of the wire harness 8 will be described below.

In FIG. 1 B, a wire harness 8 includes three high tension electric wires 39 (electrically conductive paths), an electromagnetic shield member 40 (a shield member) which shields the three high tension electric wires 39 together, an outer sheath member 41 provided outside the electromagnetic shield member 40, a motor side connecting part 42 provided in one end side of the three high tension electric wires 39 and an inverter side connecting part 43 provided in the other end side.

In FIG. 1B and FIG. 2, the high tension electric wire 39 is a high tension electrically conductive path including a conductor and an insulator (a coating) and formed so as to have a length necessary for an electric connection. The conductor is manufactured by copper or copper alloy, or aluminum or aluminum alloy. The conductor may have any of a conductor structure formed by twisting element wires, a rod shaped conductor structure with a rectangular or round section (for instance, a conductor structure having a flat rectangular single core or a round single core, and, in this case, the electric wire itself has a rod shape).

In the present exemplary embodiment, the high tension electric wires 39 are used; however, the present invention is not limited thereto. Namely, may be used a high tension electrically conductive path that is formed by providing an insulator in a known bus bar or a high tension coaxial compound electrically conductive path that is formed by providing coaxially n system circuits (n circuits) as one path.

The electromagnetic shield member 40 is formed as an electromagnetically shielding tubular member (a shield member for meeting an electromagnetic wave). Further, in the present exemplary embodiment, the electromagnetic shield member 40 is formed as a shape with which the three high tension electric wires 39 can be covered over the entire length thereof.

As the electromagnetic shield member 40, a braided shield member is used which is formed by braiding many extra fine element wires having an electric conductivity.

As for the above-described element wires, in the present exemplary embodiment, element wires made of metal such as annealed copper and/or element wires made of electrically conductive resin are used. For instance, resin wires (element wires of PET) for providing an abrasion resistance may be mixed as well as the above-described element wires. The resin wires are mixed together with the element wires made of metal and/or the element wires made of electrically conductive resin in picks forming the braided shield member.

In the shield structure according to the present invention, one end and the other end (a terminal part) of the electromagnetic shield member 40 are fixed to the motor side connecting part 42 and the inverter side connecting part 43 so as to be formed integrally therewith. Further, in the shield structure, the electromagnetic shield member 40 is connected to the shield cases 44 and 45 (electrically conductive mate members) through the motor side connecting part 42 and the inverter side connecting part 43. For convenience sake, the motor side connecting part 42 and the inverter side connecting part 43 are formed so as to have the same configurations and structures; however, the present invention is not limited thereto.

Now, the above-described shield structure will be more specifically described. The motor side connecting part 42 and the inverter side connecting part 43 are electrically conductive molded products formed by filling a metal mold with a material and formed in the same shape as that of a known metal shell in their external appearances. Since the motor side connecting part 42 and the inverter side connecting part 43 have the same form as that of the metal shell as described above, they have a function as a fixing member. Further, since the motor side connecting part 42 and the inverter side connecting part 43 have the same form as that of the metal shell, they have the forms which can be easily connected and fixed to the shield cases 44 and 45 (reference numeral 46 designates a bolt fastening through hole).

The motor side connecting part 42 and the inverter side connecting part 43 are formed so as to be used as substitutes of the known metal shell.

The motor side connecting part 42 and the inverter side connecting part 43 of the present exemplary embodiment are the electrically conductive molded products formed by filling the metal mold with the resin material having an electric conductivity. The resin material having the electric conductivity mentioned herein is a material obtained by mixing carbon fibers in the resin material such as PBT (Polybutylene terephthalate). A molding of the motor side connecting part 42 and the inverter side connecting part 43 is characterized in that the terminal part of the electromagnetic shield member 40 is integrally formed (this feature is a feature of the shield structure of the present invention).

Reference numeral 47 in the drawing designates an insert part formed by inserting the terminal part of the electromagnetic shield member 40.

As can be understood from the above-described explanation, the shield structure in which the electrically conductive molded product is formed by filling the metal mold with the resin material having the electric conductivity and the terminal part of the electromagnetic shield member 40 is also integrally formed during the molding operation is used in the wire harness 8.

The present invention is not limited to the above-described shield structure and such a shield structure as described below may be used in the wire harness 8. Namely, a shield structure may be also used in which an electrically conductive molded product is formed by filling a metal mold with molten metal and a terminal part of an electromagnetic shield member 40 is also integrally formed during the molding operation. In this case, a motor side connecting part 42 and an inverter side connecting part 43 are formed with, for instance, an aluminum die casting. Further, as the electromagnetic shield member 40, a braided shield member is made of metal element wires such as annealed copper wires.

In FIG. 1B and FIG. 3A, the outer sheath member 41 is a member that covers the three high tension electric wires 39 and the electromagnetic shield member 40 and protects them, and, for instance, a twist tube 48 is used. The twist tube 48 is formed to be wound on an outer side of the electromagnetic shield member 40 and held by a tape roll 49.

The outer sheath member 41 may be a tubular body 50 as shown in FIG. 3B. The tubular body 50 of the present exemplary embodiment is a molded product formed with an electrically conductive resin. Namely, the tubular body 50 is formed with a resin material having an electric conductivity (the resin material having the electric conductivity is, for instance, a material obtained by mixing carbon fibers in the resin material such as PBT as described above). The tubular body 50 is formed, for instance, in the shape of a pipe circular in section. When the tubular body 50 is formed, as an exemplified form, an end part of an electromagnetic shield member 40 is inserted and formed integrally therewith. Reference numeral 51 designates an insert part.

As described above by referring to FIG. 1A to FIG. 3B, in the shield structure according to the present invention, the tubular electromagnetic shield member 40 is fixed to the motor side connecting part 42 and the inverter side connecting part 43 by an integral molding. Specifically, the motor side connecting part 42 and the inverter side connecting part 43 are formed as the electrically conductive molded products. Then, an integral molding operation is carried out that the terminal part of the electromagnetic shield member 40 is integrally formed with the electrically conductive molded products respectively. Accordingly, in the shield structure of the present invention, when the electromagnetic shield member 40 is fixed and integrally formed, a working property can be effectively more improved, the number of parts can be more reduced and a cost can be more lowered than the usual example.

Further, according to the wire harness 8 of the present invention, since the above-described shield structure is used, the wire harness 8 can be effectively provided as a better wire harness 8.

### Second Exemplary Embodiment

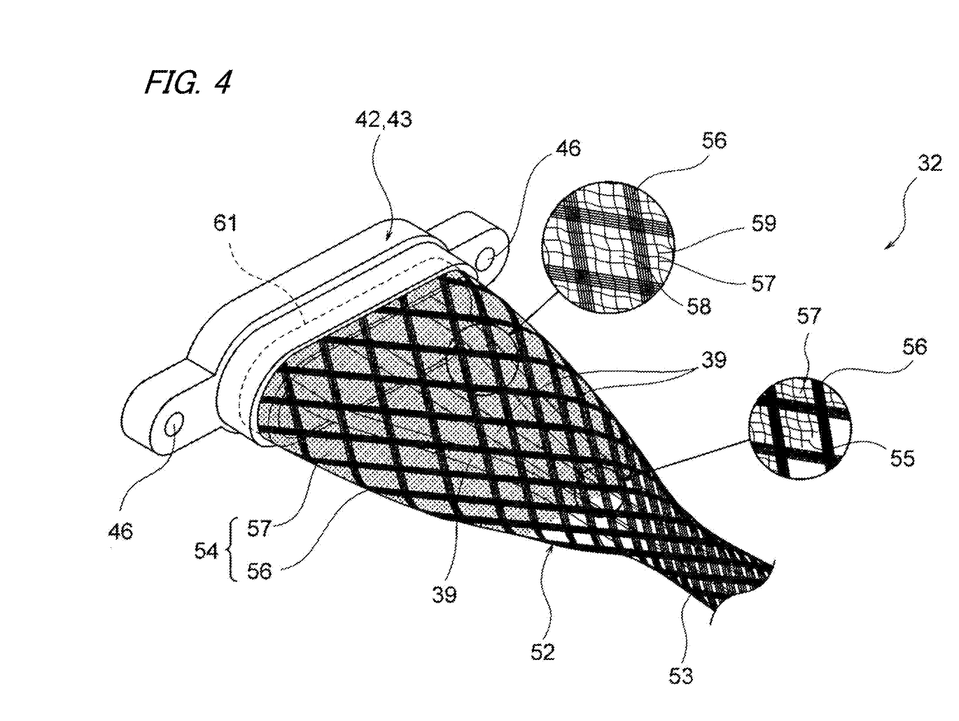

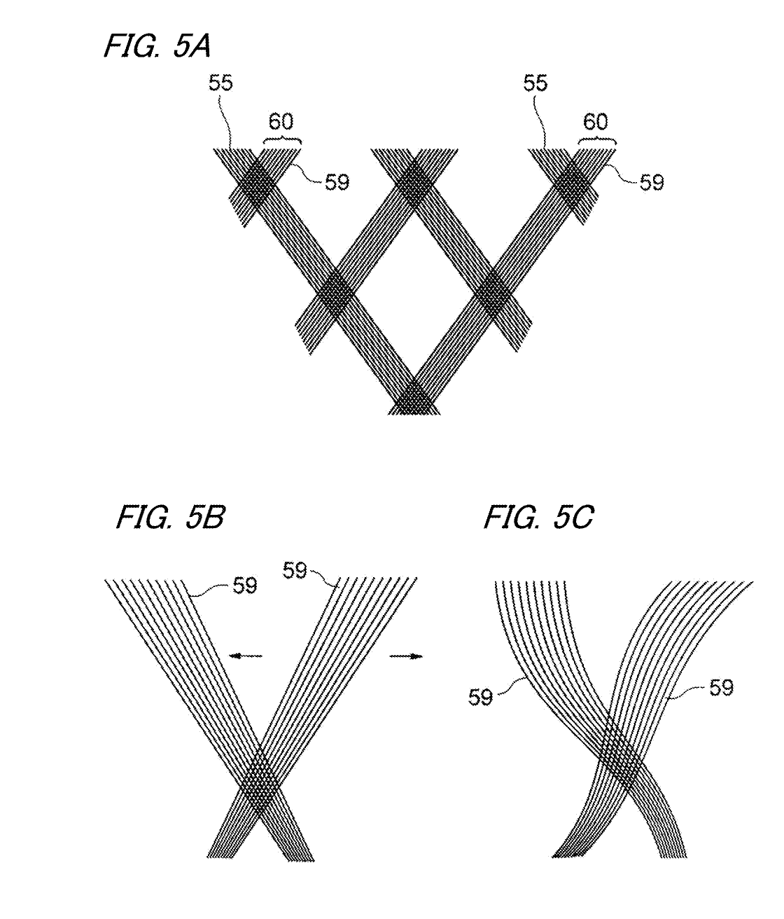

Now, referring to the drawings, a second exemplary embodiment will be described below. FIG. 4 is an enlarged perspective view of a shield structure as another exemplary embodiment (a second exemplary embodiment). FIGS. 5A and 5B are explanatory views of a loosened state of FIG. 4. The same component members as those of the first exemplary embodiment are designated by the same reference numerals and a detailed explanation thereof will be omitted. In the second exemplary embodiment, FIGS. 1A and 1B are also referred to.

In FIG. 1B and FIG. 4, a wire harness 8 wired in the same way as that of the first exemplary embodiment includes three high tension electric wires 39 (electrically conductive paths), an electromagnetic shield member 52 (a shield member) which shields the three high tension electric wires 39 together, an outer sheath member 41 provided outside the electromagnetic shield member 52, a motor side connecting part 42 provided in one end side of the three high tension electric wires 39 and an inverter side connecting part 43 provided in the other end side. In the wire harness 8 having such a structure, the same shield structure as that of the first exemplary embodiment is used.

The electromagnetic shield member 52 is formed as an electromagnetically shielding tubular member (a shield member for meeting an electromagnetic wave). Further, in the present exemplary embodiment, the electromagnetic shield member 52 is formed as a shape with which the three high tension electric wires 39 can be covered over the entire length thereof.

As the electromagnetic shield member 52, a braided shield member is used which is formed by braiding many extra fine element wires having an electric conductivity. A difference of the second exemplary embodiment form the first exemplary embodiment resides in that a below-described terminal part 54 of the electromagnetic shield member 52 has a double structure. Now, the double structure will be described below.

In FIG. 4, reference numeral 53 designates a main body part of the electromagnetic shield member 52. Further, reference numeral 54 designates the terminal part continuous to the main body part 53. The electromagnetic shield member 52 is formed in such a way that an inside diameter of the terminal part 54 is expanded more than an inside diameter of the main body part 53. In the electromagnetic shield member 52, a terminal 55 of the terminal part 54 is bent inside in the axial direction of the electromagnetic shield member 52 so as to have the double structure. Namely, the terminal part 54 is formed in the double structure having an outer terminal part 56 and an inner terminal part 57.

The electromagnetic shield member 52 is formed in the double structure under a state that the terminal 55 of the terminal part 54 is kept cut to be unfinished (the braided shield member is merely kept cut). Further, the electromagnetic shield member 52 is formed in such a way that the inner terminal part 57 has the element wires including the terminal 55 loosened under the above-described cut state. In FIG. 4, an inner side 57 of an end part (the inner terminal part) is schematically shown in a netted state. In circles shown in FIG. 4, the inner terminal part 57 is shown so as to see the loosened state.

Here, the above-described loosened state is more specifically described. As shown by a state in the circles in FIG. 4, the loosened start indicates a state in which the element wire 59 intersects a mesh 58 of the outer terminal part 56 inside thereof. In forming the loosened state, when a pick 60 formed with a plurality of element wires 59 is seen as shown in FIG. 5A, the terminal 55 as an end is kept cut (cut as it is). After that, a bundle of the element wires 59 in each of the picks 60 is formed so as to be loosened as shown in FIG. 5B to FIG. 5C. The loosened state is not especially shown in the drawing; however, the loosened state includes a state that the element wires 59 become “shaggy”.

In the above-described loosened state, the terminal 55 of the terminal part 54 is set so as to be arranged at a position continuous to the main body part 53 or at a position near the position continuous to the main body part 53.

In the shield structure according to the present invention, the terminal end parts 54 of the electromagnetic shield member 52 are fixed to the motor side connecting part 42 and the inverter side connecting part 43 so as to be formed integrally therewith. Further, in the shield structure, the electromagnetic shield member 52 is connected to shield cases 44 and 45 (electrically conductive mate members) through the motor side connecting part 42 and the inverter side connecting part 43.

The above-described shield structure is formed as an integrally formed structure including the part bent inside in the axial direction (a part corresponding to a terminal opening part of this invention) which is formed in the terminal part 54 of the electromagnetic shield member 52 like the first exemplary embodiment. Reference numeral 61 in the drawing designates an insert part formed by inserting the terminal part 54 of the electromagnetic shield member 52.

As can be understood from the above-described explanation, the shield structure in which an electrically conductive molded product is formed by filling a metal mold with a resin material or molten metal having an electric conductivity and the terminal part 54 of the electromagnetic shield member 52 is also integrally formed during the molding operation is used in the wire harness 8.

As described above by referring to FIGS. 4, 5A and 5B, in the shield structure according to the present invention, the tubular electromagnetic shield member 52 is fixed to the motor side connecting part 42 and the inverter side connecting part 43 by an integral molding. Specifically, the motor side connecting part 42 and the inverter side connecting part 43 are formed as the electrically conductive molded products. Then, an integral molding operation is carried out that the terminal part 54 of the electromagnetic shield member 52 is integrally formed with the electrically conductive molded products respectively. Accordingly, in the shield structure of the present invention, when the electromagnetic shield member 52 is fixed and integrally formed, a working property can be effectively more improved, the number of parts can be more reduced and a cost can be more lowered than the usual example.

Further, according to the wire harness 8 of the present invention, since the above-described shield structure is used, the wire harness can be effectively provided as a better wire harness 8.

As for the electromagnetic shield member 52, an opening area of the mesh 58 of the outer terminal part 56 is small. As a result, a shield performance can be effectively prevented from being deteriorated or the shield performance can be effectively sufficiently exhibited.

The electromagnetic shield member 52 is characterized as described below. Namely, the electromagnetic shield member 52 is characterized in that the electromagnetic shield member 52 includes the tubular main body part 53 and the tubular terminal part 54 continuous to the main body part 53, the inside diameter of the terminal part 54 is expanded more than the inside diameter of the main body part 53, the terminal 55 of the terminal part 54 is bent inside in the axial direction so that the terminal part 54 is formed in the double structure having the outer terminal part 56 and the inner terminal part 57, further, the terminal 55 of the terminal part 54 in the electromagnetic shield member 52 is kept cut to be unfinished and the inner terminal part 57 has the element wires 59 loosened including the terminal 55 which is kept cut.

### Third Exemplary Embodiment

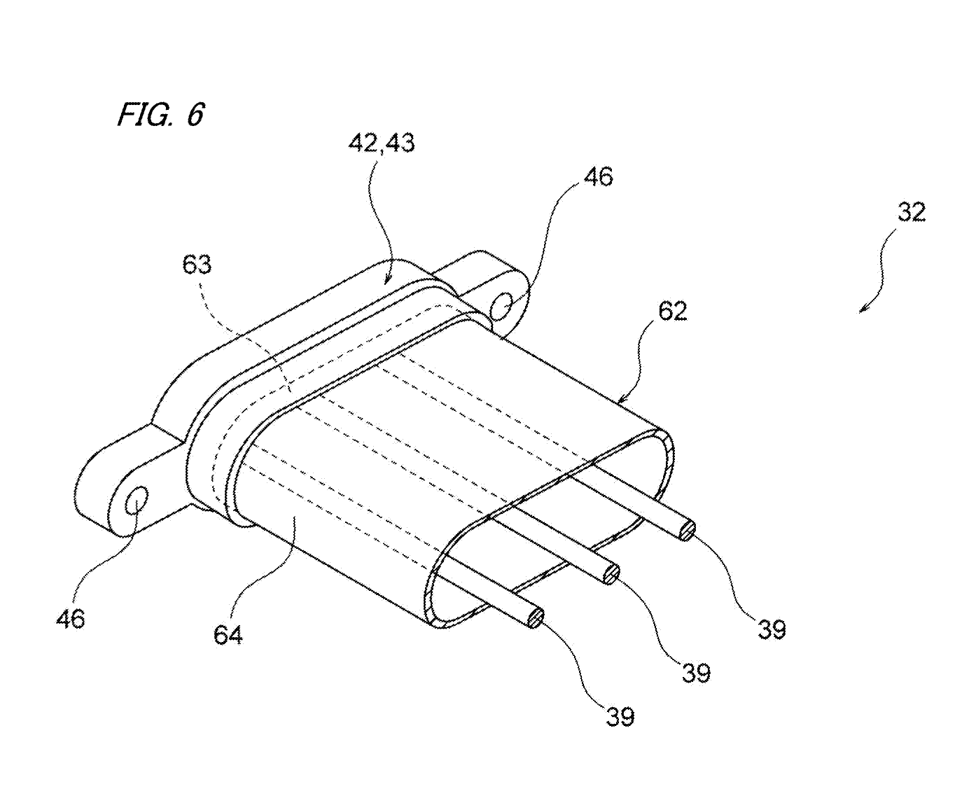

Now, referring to the drawing, a third exemplary embodiment will be described below. FIG. 6 is an enlarged perspective view of a shield structure as a still another exemplary embodiment. The same component members as those of the first and second exemplary embodiments are designated by the same reference numerals and a detailed explanation thereof will be omitted.

In FIG. 6, a shield structure of a third exemplary embodiment is different from the first and second exemplary embodiments in view of a point that an electromagnetic shield member 62 is used. The electromagnetic shield member 62 thereof is formed in a tubular shape and a terminal opening part is formed integrally with a motor side connecting part 42 and an inverter side connecting part 43. As the electromagnetic shield member 62, is used a shield member formed with a metal foil single body or a shield member including a metal foil and a resin layer as a base of the metal foil. In the third exemplary embodiment, a shield member of a type which is not a braided shield member, that is, the electromagnetic shield member 62 is used.

Reference numeral 63 shows an insert part in which a terminal part 64 of the electromagnetic shield member 62 is inserted.

It is to be understood that the above-described shield structure achieves the same effects as those of the first and second exemplary embodiments. Namely, since the electromagnetic shield member 62 is fixed by an integral molding, a working property can be effectively improved, the number of parts can be reduced and a cost can be lowered.

### Fourth Exemplary Embodiment

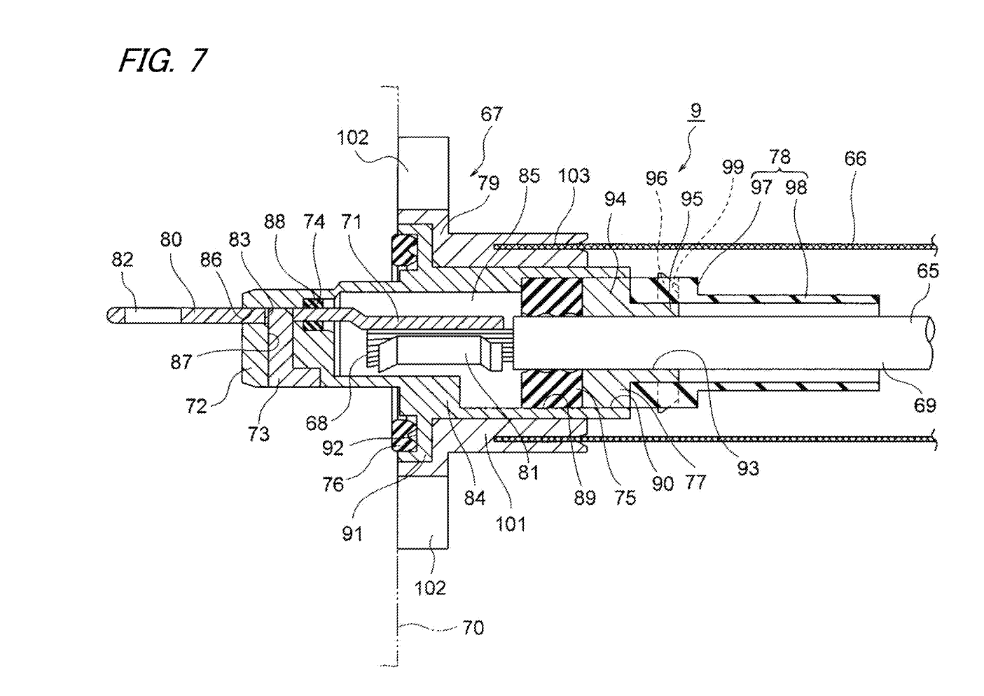

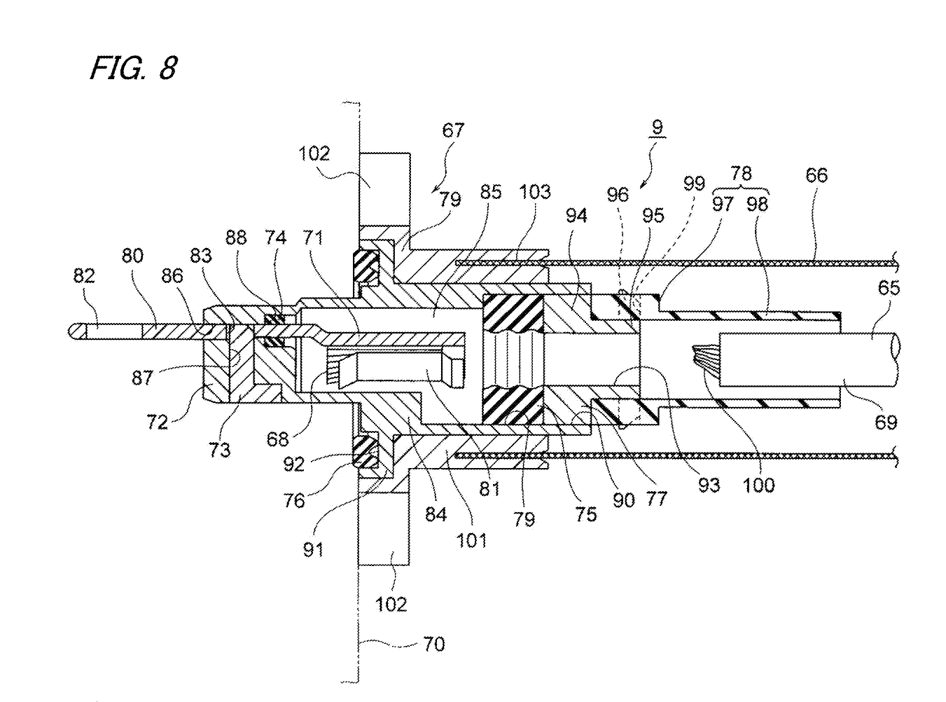

Now, referring to the drawings, a fourth exemplary embodiment will be described below. FIG. 7 is an enlarged perspective view of a shield structure as other exemplary embodiment. FIG. 8 is a sectional view showing a cut state of a high tension electric wire. In the fourth exemplary embodiment, FIGS. 1A and 1B are also referred to.

In the fourth exemplary embodiment, not a wire harness 8, but a wire harness 9 (see FIGS. 1A and 1B) will be described as an example.

In FIG. 7, a wire harness 9 includes two high tension electric wires 65 (electrically conductive paths, only one is shown herein), an electromagnetic shield member 66 (a shield member) which shields the two high tension electric wires 65 together, an outer sheath member not shown in the drawing and provided outside the electromagnetic shield member 66, an inverter side connecting part 67 provided in one end side of the high tension electric wires 65 and a battery side connecting part provided in the other end side and not shown in the drawing. For convenience sake, the battery side connecting part not shown in the drawing has the same form and structure as those of the inverter side connecting part 67; however, the present invention is not limited thereto.

The high tension electric wire 65 includes a conductor 68 and an insulator 69 which covers the conductor 68. In the high tension electric wire 65, the insulator 69 is worked so as to be peeled by a prescribed length in a terminal thereof and expose the conductor 68. As the conductor 68, a conductor structure is used herein which is formed by twisting element wires (element wires made of copper or copper alloy, or aluminum or aluminum alloy). The conductor 68 is not especially limited, however, is formed substantially in the shape of a round shape (a circular form) in section. The conductor 68 may have a rod shaped conductor structure with a rectangular or round section (for instance, a conductor structure having a flat rectangular single core or a round single core). Further, a conductor structure formed with a braided bus bar may be used.

The insulator 69 is formed by extrusion coating an outer side of the conductor 68 with a resin material having an electric conductivity. Here, a known insulator is used.

Since the high tension electric wire 65 is used for a high tension, the high tension electric wire 65 is used for a thick electric wire.

The electromagnetic shield member 66 is a member which demonstrates an electromagnetically shielding function and is manufactured by forming, for instance, a braided wire or a metal foil in a tubular shape. As the electromagnetic shield member 66 of the present exemplary embodiment, any of the electromagnetic shield member 40 (see FIG. 2) of the first exemplary embodiment, the electromagnetic shield member 52 (see FIG. 4) of the second exemplary embodiment and the electromagnetic shield member 62 (see FIG. 6) of the third exemplary embodiment is used. One end of the electromagnetic shield member 66 is formed integrally with a below-described electrically conductive resin molded product 79 of the inverter side connecting part 67 by an integral molding. Further, the other end is similarly formed integrally with the battery side connecting part not shown in the drawing.

The inverter side connecting part 67 is what is called a connector and inserted into a shield case 70 (an electrically conductive mate member) of a front inverter unit 25 so as to make an electric connection therein. The inverter side connecting part 67 includes a terminal fitting 71, a housing 72, a terminal engaging member 73, water-proof seal members 74 to 76, a rear holder 77, an insulating cover 78, the electrically conductive resin molded product 79 (an electrically conductive molded product) and a fixing bolt (an illustration is omitted).

The terminal fitting 71 is formed by a press working of a metal plate having an electric conductivity. As the terminal fitting 71, a male type is used herein. The terminal fitting 71 includes an electric contact part 80 and an electric wire connecting part 81 connected to the electric contact part 80.

The electric contact part 80 is formed in the shape of a tab. In the electric contact part 80, a first through hole 82 and a second through hole 83 are formed. The first through hole 82 is formed as a part used for the electric connection in the front inverter unit 25. On the other hand, the second through hole 83 is formed as a part engaged with the terminal engaging member 73.

The electric wire connecting part 81 is formed so as to connect and fix the conductor 68 of the high tension electric wire 65. In the present exemplary embodiment, the electric wire connecting part 81 is formed in the shape of a barrel so as to attach the conductor 68 under pressure by caulking and connect the conductor 68 (as for a connection, a welding may be applied).

The housing 72 is a resin molded product (an insulating member) having an insulating property, has a housing main body 84 and is formed in a configuration shown in the drawing (the configuration shows one example).

In an inner part of the housing main body 84, a terminal accommodating chamber 85 is formed. The terminal accommodating chamber 85 is formed so as to mainly accommodate the electric wire connecting part 81 of the terminal fitting 71 connected and fixed to the conductor 68 of the high tension electric wire 65. In the terminal accommodating chamber 85, an electric contact part leading-out hole 86 is formed which passes through toward an end of the housing. When the terminal fitting 71 is accommodated in the terminal accommodating chamber 85, the electric contact part 80 protrudes from the end of the housing through the electric contact part leading-out hole 86.

In the housing main body 84, a terminal engaging member accommodating hole 87 is formed from a lower part to an upper part which communicates with the electric contact part leading-out hole 86. In the terminal fitting 71, the second through hole 83 is engaged with the terminal engaging member 73 fitted to the terminal engaging member accommodating hole 87, so that the terminal fitting 71 is prevented from slipping out.

In a connecting part of the terminal accommodating chamber 85 and the electric contact part leading-out hole 86, a seal member accommodating hole 88 is formed. The seal member 74 accommodated in the seal member accommodating hole 88 comes into watertight contact with the electric contact part 80.

In the terminal accommodating chamber 85, a seal member accommodating hole 89 is formed so as to be continuous thereto in a rear part thereof. Further, in a rear part thereof, a rear holder accommodating hole 90 is continuously formed. The seal member 75 accommodated in the seal member accommodating hole 89 comes into watertight contact with the insulator 69 of the high tension electric wire 65. The rear holder accommodating hole 90 is formed in a configuration to which the rear holder 77 can be fitted.

In an outer part of the housing main body 84, a flange part 91 is formed. In the flange part 91, a seal member accommodating groove 92 is formed. The seal member 76 accommodated in the seal member accommodating groove 92 comes into watertight contact with the shield case 70 of the front inverter unit 25.

The rear holder 77 is a resin molded product having an insulating property and is formed in a configuration which can be divided into two parts, though not especially shown in the drawing. The rear holder 77 includes an electric wire insert hole 93 which passes through so as to meet a diameter of the high tension electric wire 65, a large diameter fitting part 94 fitted to the rear holder accommodating hole 90, a small diameter electric wire leading-out part 95 which leads out the high tension electric wire 65 continuously to the fitting part 94 and an engaging protrusion 96 formed to protrude in, for instance, upper and lower parts, in an end part of the electric wire leading-out part 95. The engaging protrusion 96 is formed to be engaged with the insulating cover 78 so as to restrain the insulating cover from slipping out.

The insulating cover 78 is provided as a separate member from the rear holder 77. Further, the insulating cover 78 is provided as a member having flexibility and made of rubber, herein. The insulating cover 78 is formed in a tubular shape and has a large diameter engaging part 97 and a cover part 98 extending rearward from the engaging part 97. In the engaging part 97, an engaging recessed part 99 is formed which is caught by and engaged with the engaging protrusion 96 of the rear holder 77.

If an external force is applied to the wire harness 9, it may be said that the insulating cover 78 is an effective member. Now, reasons thereof will be described below.

If the external force is applied to a wire harness 9, the external force is applied to the conductor 68 of the high tension electric wire 65 and a connecting part of the electric wire connecting part 81 of the terminal fitting 71. Then, the conductor 68 in the connecting part is cut as shown in FIG. 8. Specifically, the conductor 68 is cut in such a state that a part of the conductor 68 is left in a caulking part in the electric wire connecting part 81 and a conductor cut end part 100 is exposed in the high tension electric wire 65 side. At this time, although the conductor cut end part 100 is exposed in the high tension electric wire 65, an outer side of the conductor cut end part 100 is covered with the insulating cover 78. Accordingly, an electric contact to the electromagnetic shield member 66 is regulated (when a moving amount is small, the outer side of the conductor cut end part 100 is covered with the housing main body 84, or the fitting part 94 or the electric wire leading out part 95 of the rear holder 77, so that the electric contact is regulated).

Accordingly, the conductor cut end part 100 is prevented from being exposed due to the existence of the insulating cover 78 so that a safety may be ensured. Thus, it may be said that the insulating cover 78 is effective member when the external force is applied to the wire harness.

The electrically conductive resin molded product 79 is a substitute of what is called a metal shell (a shield shell) and formed by filling a metal mold with a resin material having an electric conductivity. The electrically conductive resin molded product 79 includes a substantially tubular molded product main body 101 (a shell main body) and a plurality of molded product fixing parts 102 (shell fixing parts). The molded product main body 101 is formed in a configuration in which the housing main body 84 can be accommodated. The molded product fixing part 102 is formed in a configuration which is fixed to the shield case 70 of the front inverter unit 25 by using the fixing bolt not shown in the drawing.

In the molded product main body 101, a terminal part of the electromagnetic shield member 66 is integrally formed. Reference numeral 103 in the drawing designates an insert part in the terminal part of the electromagnetic shield member 66.

As apparent from the above-described explanation, the shield structure in which the electrically conductive resin molded product 79 is formed by filling the metal mold with the resin material having the electric conductivity, and the terminal part of the electromagnetic shield member 66 is also integrally formed during the molding operation is used in the wire harness 9.

It is to be understood that the above-described shield structure achieves the same effects as those of the first to third exemplary embodiments. Namely, since the electromagnetic shield member 66 is fixed and integrally formed by an integral molding of a resin, a working property can be effectively improved, the number of parts can be reduced and a cost can be lowered.

It is apparent that various modifications can be made in the invention within a scope not deviating from the gist of the invention.

The present application is based on Japanese patent application No. 2011-256942 filed on Nov. 25, 2011, and the contents of the patent application are incorporated herein by reference.

### INDUSTRIAL APPLICABILITY

The present invention is useful for providing a shield structure and a wire harness which can improve a working property, reduce the number of parts and lower a cost when a shield member is fixed and integrally formed.

### REFERENCE SIGNS LIST

1 . . . hybrid motor vehicle 2 . . . engine 3 . . . motor unit 4 . . . inverter unit 5 . . . battery 6 . . . engine room 7 . . . rear part of motor vehicle 8 . . . high tension wire harness 9 . . . wire harness 10 . . . intermediate part 11 . . . under-floor of vehicle body 12 . . . junction block 13 . . . rear end 14 . . . front end 39 . . . high tension electric wire (electrically conductive path) 40 . . . electromagnetic shield member (shield member) 41 . . . outer sheath member 42 . . . motor side connecting part (electrically conductive molded product, fixing member) 43 . . . inverter side connecting part (electrically conductive molded product, fixing member) 44, 45 . . . shield case (electrically conductive mate member) 46 . . . through hole 47 . . . insert part 48 . . . twist tube 49 . . . tape roll 50 . . . tubular body (electrically conductive molded product) 51 . . . insert part 52 . . . electromagnetic shield member (shield member) 53 . . . main body part 54 . . . terminal part 55 . . . terminal 56 . . . outer terminal part 57 . . . inner terminal part 58 . . . mesh 59 . . . element wire 60 . . . pick 61 . . . insert part 62 . . . electromagnetic shield member (shield member) 67 . . . inverter side connecting part 71 . . . terminal fitting 72 . . . housing 73 . . . terminal engaging member 74 to seal member 77 . . . rear holder 78 . . . insulaitng cover 79 . . . electrically conductive resin molded product (electrically conductive molded product) 98 . . . engaging protrusion 97 . . . engaging part 98 . . . cover part 99 . . . engaging recessed part 100 . . . conductor cut end part 101 . . . .molded product main body 102 . . . molded product fixing part 103 . . . insert part

1. A shield structure having a shield member and an electrically conductive molded product, in which a terminal part of the shield member formed in a tubular shape is formed integrally with the electrically conductive molded product.

2. A shield structure according to claim 1, wherein the molded product is formed as a fixing member fixed to a mate member having an electric conductivity.

3. A shield structure according to claim 1, wherein the molded product is formed in the shape of a tubular body.

4. A wire harness including:
one or a plurality of electrically conductive paths;
a shield member which is formed in a tubular shape and covers the one or the plurality of electrically conductive paths and
an electrically conductive molded product formed integrally with a terminal part of the shield member.
